(19) United States
(12) Patent Application Publication
(10) Pub. No.: US 2021/0216640 A1
(43) Pub. Date: Jul. 15, 2021

(54) SYSTEMS AND METHODS FOR HARDWARE ROOT OF TRUST WITH PROTECTED REDUNDANT MEMORY FOR AUTHENTICATION FAILURE SCENARIOS

(71) Applicant: Dell Products L.P., Round Rock, TX (US)

(72) Inventors: Richard J. BOYLE, Quincy, MA (US); Andrew WROBEL, Oxford, MA (US); Samant KAKARLA, Wellesley, MA (US); Ryan C. MCDANIEL, Hopkinton, MA (US)

(73) Assignee: Dell Products L.P., Round Rock, TX (US)

(21) Appl. No.: 16/740,277

(22) Filed: Jan. 10, 2020

(51) Int. Cl. G06F 21/57; G06F 21/60; G06F 21/62; G06F 11/14; G06F 21/56

(52) U.S. Cl. CPC G06F 21/575; G06F 21/602; G06F 21/6218; G06F 2201/805; G06F 21/566; G06F 2221/034; G06F 11/1469

(57) ABSTRACT

A cryptoprocessor may comprise processing logic configured to upon powering up of a management controller communicatively coupled to a processor of an information handling system and configured to provide management of the information handling system via management traffic communicated between the management controller and a dedicated management network external to the information handling system, preventing the management controller from booting, attempt to authenticate a primary executable code image stored in a primary memory and a backup image to the primary executable code image stored in a secondary memory, and responsive to at least one of the primary executable code image and the backup image being authenticated, allow the management controller to execute an authenticated image comprising one of the primary executable code image and the backup image.

### TECHNICAL FIELD

The present disclosure relates in general to information handling systems, and more particularly to methods and systems for providing a hardware root of trust with a protected redundant memory for authentication failures.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With new and dangerous security threats becoming ever more prevalent in enterprise computing, increasingly robust solutions are needed to ensure the authenticity of code executing in information handling systems. One of the most difficult places to ensure code authenticity is the bootloader space in a baseboard management controller (BMC) or other management controller, which can act as a trusted authority for other downstream firmware elements. If a rogue agent compromises the BMC, the rogue agent may have access to both primary and secondary bootloader images stored in memory and may be able to compromise both, given enough familiarity with the system. Accordingly, methods and systems for ensuring code authenticity while maintaining redundancy of bootloader images may be desired.

### SUMMARY

In accordance with the teachings of the present disclosure, the disadvantages and problems associated with existing approaches for ensuring code authenticity while maintaining desired redundancy for code in an information handling system may be reduced or eliminated.

In accordance with embodiments of the present disclosure, an information handling system may include a processor, a management controller communicatively coupled to the processor and configured to provide management of the information handling system via management traffic communicated between the management controller and a dedicated management network external to the information handling system, a primary memory for storing a primary executable code image associated with the management controller, a secondary memory for storing a backup image to the primary executable code image, and a cryptoprocessor communicatively coupled to the management controller. The cryptoprocessor may be configured to, upon powering up of the management controller, preventing the management controller from booting from either of the primary executable code image and the backup image, attempt to authenticate the primary executable code image and the backup image, and responsive to at least one of the primary executable code image and the backup image being authenticated, allow the management controller to execute an authenticated image comprising one of the primary executable code image and the backup image.

In accordance with these and other embodiments of the present disclosure, a method may be provided for us in an information handling system comprising a processor, a management controller communicatively coupled to the processor and configured to provide management of the information handling system via management traffic communicated between the management controller and a dedicated management network external to the information handling system, a primary memory for storing a primary executable code image associated with the management controller, and a secondary memory for storing a backup image to the primary executable code image. The method may comprise upon powering up of the management controller, preventing the management controller from booting from either of the primary executable code image and the backup image, attempting to authenticate the primary executable code image and the backup image, and responsive to at least one of the primary executable code image and the backup image being authenticated, allow the management controller to execute an authenticated image comprising one of the primary executable code image and the backup image.

In accordance with these and other embodiments of the present disclosure, a cryptoprocessor may comprise processing logic configured to upon powering up of a management controller communicatively coupled to a processor of an information handling system and configured to provide management of the information handling system via management traffic communicated between the management controller and a dedicated management network external to the information handling system, preventing the management controller from booting, attempt to authenticate a primary executable code image stored in a primary memory and a backup image to the primary executable code image stored in a secondary memory, and responsive to at least one of the primary executable code image and the backup image being authenticated, allow the management controller to execute an authenticated image comprising one of the primary executable code image and the backup image.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flowchart of an example method providing a hardware root of trust with a protected redundant memory for authentication failures, in accordance with embodiments of the present disclosure.

### DETAILED DESCRIPTION

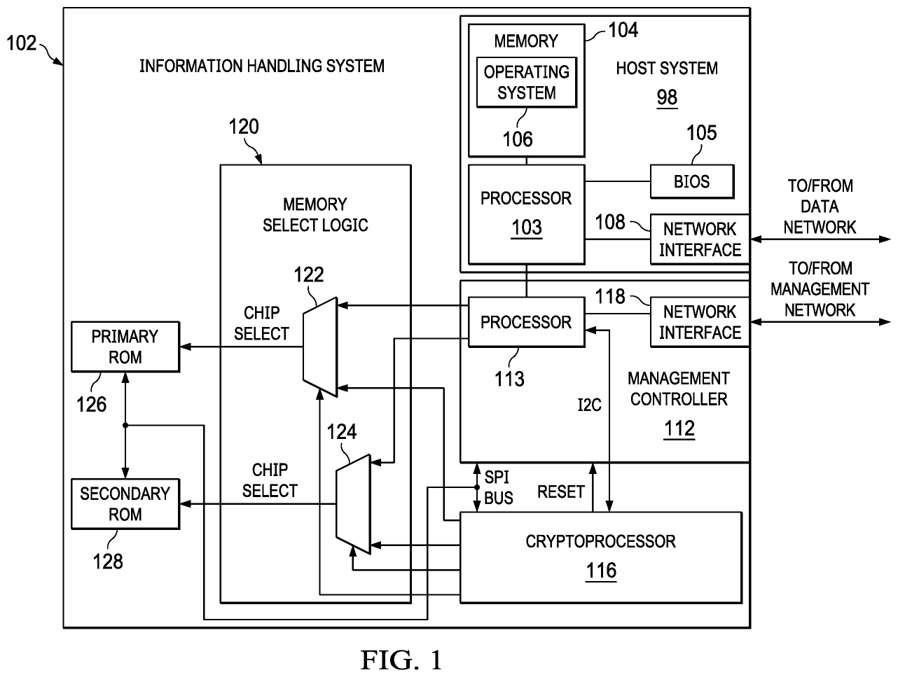

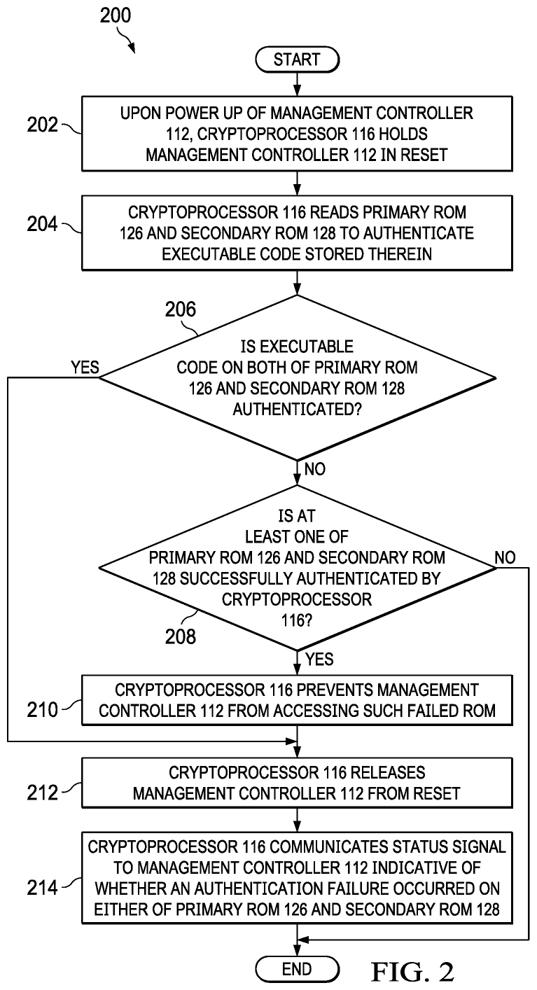

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a network interface 108 communicatively coupled to processor 103, a management controller 112 communicatively coupled to processor 103, a cryptoprocessor 116 communicatively coupled to a processor 113, memory select logic 120, a primary read-only memory (ROM) 126 and a secondary ROM 128.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Network interface 108 may comprise any suitable system, apparatus, or device operable to serve as an interface between information handling system 102 and one or more other information handling systems via an in-band management network. Network interface 108 may enable information handling system 102 to communicate using any suitable transmission protocol and/or standard. In these and other embodiments, network interface 108 may comprise a network interface card, or “NIC.” In some embodiments, network interface 108 may comprise a 10 gigabit Ethernet network interface. In these and other embodiments, network interface 108 may be enabled as a local area network (LAN)-on-motherboard (LOM) card.

In operation, processor 103, memory 104, BIOS 105, and network interface 108 may comprise at least a portion of a host system 98 of information handling system 102. Although FIG. 1 depicts host system 98, in some embodiments of the present disclosure, information handling system 102 may not include a host system 98.

Management controller 112 may be configured to provide management facilities for management of information handling system 102. Such management may be made by management controller 112 even if information handling system 102 is powered off or powered to a standby state. Management controller 112 may include a processor 113, memory, and a management network interface 118 separate from and physically isolated from data network interface 108. In certain embodiments, management controller 112 may include or may be an integral part of a baseboard management controller (BMC) or a remote access controller (e.g., a Dell Remote Access Controller or Integrated Dell Remote Access Controller). As shown in FIG. 1, management controller 112 may comprise a processor 113 and a network interface 118 communicatively coupled to processor 113.

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in a memory and/or another component of information handling system 102 or management controller 112. As shown in FIG. 1, processor 113 may be communicatively coupled to processor 103. Such coupling may be via a Universal Serial Bus (USB), System Management Bus (SMBus), and/or one or more other communications channels.

Network interface 118 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” In some embodiments, network interface 118 may comprise a 1 gigabit Ethernet network interface.

Cryptoprocessor 116 may be communicatively coupled to processor 113 (e.g., via an I2C bus) and may include any system, device, or apparatus configured to carry out cryptographic operations on data communicated to it from processor 113 and/or another component of management controller 112. In some embodiments, cryptoprocessor 116 may be dedicated to management controller 112. In some embodiments, cryptoprocessor 116 may be compliant with the Trusted Platform Module (TPM) specification, a successor specification, and/or any other similar specification. In some embodiments, cryptoprocessor 116 may be configured to generate random numbers, generate encryption keys (e.g., RSA keys), generate and maintain hash key tables of hardware and software components associated with management controller 112, generate and maintain configuration parameters associated with hardware and software components of management controller 112, wrap (e.g., encrypt) keys, unwrap (e.g., decrypt) keys, and/or store keys (e.g., endorsement key, storage root key, attestation identity keys, storage keys).

Memory select logic 120 may comprise any suitable system, device, or apparatus configured to, as described in greater detail below, control access by management controller 112 to primary ROM 126 and secondary ROM 128. For example, memory select logic 120 may include a multiplexer 122 and a multiplexer 124.

Multiplexer 122 may comprise any system, device, or apparatus configured to, based on a control signal from cryptoprocessor 116, selectively couple primary ROM 126 to one of management controller 112 and cryptoprocessor 116.

Similarly, multiplexer 124 may comprise any system, device, or apparatus configured to, based on a control signal from cryptoprocessor 116, selectively couple secondary ROM 128 to one of management controller 112 and cryptoprocessor 116.

Primary ROM 126 may include any system, device, or apparatus configured to retain program instructions and/or data for a period of time, and may include non-volatile memory that retains data after power to information handling system 102 is turned off. For example, in some embodiments, primary ROM 126 may comprise a flash storage device. In some embodiments, primary ROM 126 may store thereon one or more code images, including firmware for management controller 112, a bootloader for management controller 112, or other executable code.

Secondary ROM 128 may include any system, device, or apparatus configured to retain program instructions and/or data for a period of time, and may include non-volatile memory that retains data after power to information handling system 102 is turned off. For example, in some embodiments, secondary ROM 128 may comprise a flash storage device. In some embodiments, secondary ROM 128 may store thereon one or more code images, including a recovery image for the one or more code images stored on primary ROM 126.

In addition to processor 103, memory 104, network interface 108, management controller 112, cryptoprocessor 116, memory select logic 120, primary ROM 126, and secondary ROM 128, information handling system 102 may include one or more other information handling resources.

In operation, upon powering up of management controller 112 (e.g., cold power up or any reset event to management controller 112), cryptoprocessor 116 may hold management controller 112 in reset (e.g., via a suitable signal communicated via a reset pin of management controller 112). Cryptoprocessor 116 may then read primary ROM 126 and secondary ROM 128 and authenticate executable code stored therein (e.g., a bootloader for management controller 112). Upon completion of the authentication process, cryptoprocessor 116 may determine whether to release management controller 112 from reset. If either of the code images are present, primary ROM 126 and secondary ROM 128 are successfully authenticated by cryptoprocessor 116, and cryptoprocessor 116 may release management controller 112 from reset.

However, if an executable code image stored in either of primary ROM 126 and secondary ROM 128 is unable to be authenticated, cryptoprocessor 116 may generate one or more control signals (e.g., mux select signals to one or both of multiplexer 122 and multiplexer 124) preventing management controller 112 from accessing such unauthenticated code image. Accordingly, cryptoprocessor 116 may prevent any read or write operation issued by management controller 112 from succeeding to unauthenticated code.

Furthermore, management controller 112 may include hardware watchdog functionality to failover to secondary ROM 128 automatically if primary ROM 126 has become compromised and management controller 112 is not permitted by cryptoprocessor 116 to access primary ROM 126. In addition, during boot up after it is released from reset, management controller 112 may receive status information from cryptoprocessor 116 indicative of whether an authentication failure occurred on either of primary ROM 126 or secondary ROM 128. If authentication failed on either of primary ROM 126 or secondary ROM 128, management controller 112 may communicate a request to cryptoprocessor 116 to grant management controller 112 access to such primary ROM 126 or secondary ROM 128, in order to recover the code image on whichever of primary ROM 126 or secondary ROM 128 failed authentication.

In addition, assuming the executable code on both of primary ROM 126 or secondary ROM 128 may authenticate, cryptoprocessor 116 may still prevent management controller 112 from accessing secondary ROM 128 (e.g., in absence of an authenticated sideband request to secondary ROM 128), such that all attempted read or write applications by management controller 112 may fail, thus preventing a malicious attack that may compromise the executable code of secondary ROM 128.

Thus, in accordance with the above described functionality, cryptoprocessor 116 in concert with memory select logic 120 may provide redundancy of executed code while ensuring that if a code integrity violation occurs in any of primary ROM 126 or secondary ROM 128, a method exists to failover to a backup image that is blocked from access by management controller 112 during standard runtime operation.

FIG. 2 illustrates a flowchart of an example method 200 providing a hardware root of trust with a protected redundant memory for authentication failures, in accordance with embodiments of the present disclosure. According to certain embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, upon powering up of management controller 112 (e.g., cold power up or any reset event to management controller 112), cryptoprocessor 116 may hold management controller 112 in reset (e.g., via a suitable signal communicated via a reset pin of management controller 112).

At step 204, cryptoprocessor 116 may then read primary ROM 126 and secondary ROM 128 and authenticate executable code stored therein (e.g., a bootloader for management controller 112).

At step 206, cryptoprocessor 116 may determine whether executable code on both of primary ROM 126 and secondary ROM 128 are authenticated. If executable code on both of primary ROM 126 and secondary ROM 128 are authenticated, method 200 may proceed to step 212. Otherwise, method 200 may proceed to step 208.

At step 208, cryptoprocessor 116 may determine whether at least one of primary ROM 126 and secondary ROM 128 are successfully authenticated by cryptoprocessor 116. If at least one of primary ROM 126 and secondary ROM 128 are successfully authenticated by cryptoprocessor 116, method 200 may proceed to step 210. Otherwise, if neither of primary ROM 126 and secondary ROM 128 are successfully authenticated by cryptoprocessor 116, cryptoprocessor 116 may hold management controller 112 in reset to prevent execution of compromised code within both of primary ROM 126 and secondary ROM 128, and method 200 may end.

At step 210, responsive to one of primary ROM 126 and secondary ROM 128 failing authentication, cryptoprocessor 116 may generate one or more control signals (e.g., mux select signals to one or both of multiplexer 122 and multiplexer 124) preventing management controller 112 from accessing such failed ROM. Accordingly, cryptoprocessor 116 may prevent any read or write operation issued by management controller 112 from succeeding to unauthenticated code stored on such failed ROM. Management controller 112 may include hardware watchdog functionality to failover to secondary ROM 128 automatically if primary ROM 126 has become compromised and management controller 112 is not permitted by cryptoprocessor 116 to access primary ROM 126.

At step 212, in response to at least one of primary ROM 126 and secondary ROM 128 being successfully authenticated by cryptoprocessor 116, cryptoprocessor 116 may release management controller 112 from reset.

At step 214, cryptoprocessor 116 may communicate a status signal to management controller 112 indicative of whether an authentication failure occurred on either of primary ROM 126 and secondary ROM 128. Thus, if authentication failed on either of primary ROM 126 and secondary ROM 128, management controller 112 may communicate a request to cryptoprocessor 116 to grant management controller 112 access to such primary ROM 126 or secondary ROM 128, in order to recover the code image on whichever of primary ROM 126 or secondary ROM 128 failed authentication. After completion of step 214, method 200 may end.

Although FIG. 2 discloses a particular number of steps to be taken with respect to method 200, it may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a management controller communicatively coupled to the processor and configured to provide management of the information handling system via management traffic communicated between the management controller and a dedicated management network external to the information handling system;
a primary memory for storing a primary executable code image associated with the management controller;
a secondary memory for storing a backup image to the primary executable code image; and
a cryptoprocessor communicatively coupled to the management controller and configured to:
upon powering up of the management controller, preventing the management controller from booting from either of the primary executable code image and the backup image;
attempt to authenticate the primary executable code image and the backup image; and
responsive to at least one of the primary executable code image and the backup image being authenticated, allow the management controller to execute an authenticated image comprising one of the primary executable code image and the backup image.

2. The information handling system of claim 1, wherein the cryptoprocessor is further configured to, responsive to one of the primary executable code image and the backup image failing authentication, prevent the management controller from accessing a memory comprising one of the primary memory and the secondary memory having stored thereon the one of the primary executable code image and the backup image that failed authentication.

3. The information handling system of claim 1, wherein the cryptoprocessor is further configured to, responsive to one of the primary executable code image and the backup image failing authentication, communicate an indication to the management controller of such failed authentication.

4. The information handling system of claim 3, wherein, responsive to the indication, the management controller is configured to request the cryptoprocessor to allow the management controller to access a memory comprising one of the primary memory and the secondary memory having stored thereon the one of primary executable code image and the backup image that failed authentication, to allow the management controller to recover the one of the primary executable code image and the backup image that failed authentication.

5. The information handling system of claim 1, wherein the cryptoprocessor is further configured to, responsive to both of the primary executable code image and the backup image being authenticated, prevent the management controller from accessing the secondary memory during runtime of the management controller in absence of an authenticated sideband request to the secondary memory.

6. The information handling system of claim 1, wherein the management controller comprises a baseboard management controller.

7. The information handling system of claim 1, wherein the primary executable code image comprises a bootloader of the management controller.

8. A method comprising, in an information handling system comprising a processor, a management controller communicatively coupled to the processor and configured to provide management of the information handling system via management traffic communicated between the management controller and a dedicated management network external to the information handling system, a primary memory for storing a primary executable code image associated with the management controller, and a secondary memory for storing a backup image to the primary executable code image:
upon powering up of the management controller, preventing the management controller from booting from either of the primary executable code image and the backup image;
attempting to authenticate the primary executable code image and the backup image; and
responsive to at least one of the primary executable code image and the backup image being authenticated, allow the management controller to execute an authenticated image comprising one of the primary executable code image and the backup image.

9. The method of claim 8, further comprising, responsive to one of the primary executable code image and the backup image failing authentication, preventing the management controller from accessing a memory comprising one of the primary memory and the secondary memory having stored thereon the one of the primary executable code image and the backup image that failed authentication.

10. The method of claim 8, further comprising, responsive to one of the primary executable code image and the backup image failing authentication, communicating an indication to the management controller of such failed authentication.

11. The method of claim 10, wherein, responsive to the indication, the management controller is configured to request access to a memory comprising one of the primary memory and the secondary memory having stored thereon the one of the primary executable code image and the backup image that failed authentication, to allow the management controller to recover the one of the primary executable code image and the backup image that failed authentication.

12. The method of claim 8, further comprising, responsive to both of the primary executable code image and the backup image being authenticated, preventing the management controller from accessing the secondary memory during runtime of the management controller in absence of an authenticated sideband request to the secondary memory.

13. The method of claim 8, wherein the management controller comprises a baseboard management controller.

14. The method of claim 8, wherein the primary executable code image comprises a bootloader of the management controller.

15. A cryptoprocessor comprising processing logic configured to:
upon powering up of a management controller communicatively coupled to a processor of an information handling system and configured to provide management of the information handling system via management traffic communicated between the management controller and a dedicated management network external to the information handling system, preventing the management controller from booting;
attempt to authenticate a primary executable code image stored in a primary memory and a backup image to the primary executable code image stored in a secondary memory; and
responsive to at least one of the primary executable code image and the backup image being authenticated, allow the management controller to execute an authenticated image comprising one of the primary executable code image and the backup image.

16. The cryptoprocessor of claim 15, wherein the cryptoprocessor is further configured to, responsive to one of the primary executable code image and the backup image failing authentication, prevent the management controller from accessing a memory comprising one of the primary memory and the secondary memory having stored thereon the one of the primary executable code image and the backup image that failed authentication.

17. The cryptoprocessor of claim 15, wherein the cryptoprocessor is further configured to, responsive to one of the primary executable code image and the backup image failing authentication, communicate an indication to the management controller of such failed authentication.

18. The cryptoprocessor of claim 17, wherein, responsive to the indication, the management controller is configured to request the cryptoprocessor to allow the management controller to access a memory comprising one of the primary memory and the secondary memory having stored thereon the one of the primary executable code image and the backup image that failed authentication, to allow the management controller to recover the one of the primary executable code image and the backup image that failed authentication.

19. The cryptoprocessor of claim 15, wherein the cryptoprocessor is further configured to, responsive to both of the primary executable code image and the backup image being authenticated, prevent the management controller from accessing the secondary memory during runtime of the management controller in absence of an authenticated sideband request to the secondary memory.

20. The cryptoprocessor of claim 15, wherein the management controller comprises a baseboard management controller.

21. The cryptoprocessor of claim 15, wherein the primary executable code image comprises a bootloader of the management controller.
